(19) United States
(12) Patent Application Publication
(10) Pub. No.: US 2002/0025712 A1
(43) Pub. Date: Feb. 28, 2002

(54) Connector system

(75) Inventors: Shinji Mochizuki, Shizuoka-ken (JP); Kentaro Nagai, Shizuoka-ken (JP)

Correspondence Address: Finnegan, Henderson, Farabrow,, Garrett & Dunner, L.L.P., 1300 I Street, N.W., Washington, DC, 20005-3315, US

(73) Assignee: Yazaki Corporation

(21) Appl. No.: 09/939,758

(22) Filed: Aug. 28, 2001

(30) Foreign Application Priority Data
Aug. 31, 2000 (JP) P2000-262868

(51) Int. Cl. H01R 13/627

(52) U.S. Cl. 439/357

(57) ABSTRACT

A first connector (3) includes: a first housing (12); and a pair of rotary members (13) supported on the first housing (12) for rotating in opposite directions to each other. Rotary members (13) each include: a first engagement member (21, 22); and a second connector (4) configured to be mated with the first connector (3). The second connector (4) includes a second housing (27) configured to be mated with the first housing (12). The second housing (12) includes a pair of first mating engagement members (36). First mating engagement members (36) are each configured to be abutted on the first engagement member for rotating a rotary member (13) and to be locked with the first engagement member (21, 22). The second housing (27) includes a pair of cuts (35). Cuts (35) each are for inserting the rotary member (13) thereinto when the rotary member (13) rotates.

### BACKGROUND OF THE INVENTION

The present invention relates to a connector system, and, more specifically, to a connector system for supporting and fixing joined mating internal and external connectors to a mounting component.

### SUMMARY OF THE INVENTION

An object of the present invention is to provide a connector system for enlarging the amount of rotation without requiring the lengthening of the engagement lever.

To achieve the object, a first aspect of the invention provides the following connector system. A first connector includes: a first housing; and a pair of rotary members supported on the first housing for rotating in opposite directions to each other. Rotary members each include: a first engagement member; and a second connector configured to be mated with the first connector. The second connector includes a second housing configured to be mated with the first housing. The second housing includes a pair of first mating engagement members. First mating engagement members are each configured to be abutted on the first engagement member for rotating a rotary member and to be locked with the first engagement member. The second housing includes a pair of cuts. Cuts each are for inserting the rotary member thereinto, depending on a rotation of the rotary member.

Preferably, the first engagement members each include a first protrusion configured to be abutted on a first mating engagement member. The first protrusion is to be rotated on the first mating engagement member when the rotary member rotates. The first engagement members each include a second protrusion depart from the first protrusion at a rotational angle. The second protrusion is configured to be moved around the rotary member and to be opposed to the first protrusion relative to the first mating engagement member when the rotary member rotates.

Preferably, the pair of rotary members each include: a second engagement member configured to be locked with a mounting object. The second engagement member is to be slid against the mounting object when the rotary member rotates.

Preferably, the second engagement member is opposed to a first engagement member relative to a rotational axis of the rotary member.

Preferably, the rotary members each include: a locking member locked with the first housing. The locking member is to be disengaged when the first housing is mated with the second housing.

Preferably, respective rotary members include respective gears meshed with each other.

Preferably, respective rotary members include respective biasing members biased against each other.

A second aspect of the invention provides the following connector system. The connector system includes a first connector having an engagement lever rotatably supported thereon. The connector system includes a second connector configured to be mated with the first connector. The second connector has a housing formed with a slit. The second connector is configured to rotate the engagement lever for inserting a side portion of a free end of the engagement lever into the slit.

Preferably, with the free end being locked with a mounting component, pressing of the second connector to the first connector causes the first connector to be inserted into the housing. A rotation of the engagement lever causes first and second connectors to be mated with each other.

According to the aspects, when the first connector is mated with the second connector, the engagement lever rotates for housing a side portion of its free end into the cut formed to the housing of the second connector. This allows the engagement lever to increase in the amount of rotational motion thereof, thus enlarging the amount of the mating movement without requiring the lengthening of the engagement lever.

Due to the mating of the first connector with the second connector, the insertion of the side portion of the free end supported on the first connector into the cut formed to the second connector.

### BRIEF DESCRIPTION OF THE ACCOMPANYING DRAWINGS

The above and further objects and novel features of the present invention will emerge more fully from the following detailed description when the same is read in conjunction with the accompanying drawings, in which:

FIG. 1 is a perspective view of a connector system according to an embodiment of the invention;

FIG. 2 is an elevation view of a mounting component of the embodiment;

FIG. 3 is a plan view of a mounting component of the embodiment;

FIG. 4 is a sectional view taken along A1-A1 line in FIG. 2;

FIG. 5 is a perspective view showing internal and external connectors of the embodiment;

FIG. 6 is an elevation view showing a state where an external connector is mounted to mounting component;

FIG. 7 is a sectional view taken along B1-B1 line in FIG. 6;

FIG. 8 is an elevation view showing the internal connector of the embodiment;

FIG. 9 is a sectional view taken along C1-C1 line in FIG. 8;

FIG. 10 is a sectional view taken along D1-D1 line in FIG. 8;

FIG. 11 is an explanatory plan view showing internal and external connectors of the embodiment in an initial stage of mating;

FIG. 12 is an explanatory plan view showing internal and external connectors of the embodiment during mating;

FIG. 13 is an explanatory plan view showing internal and external connectors during mating and a provisional engaging abutment piece in a state of disengagement;

FIG. 14 is an explanatory plan view showing internal and external connectors during mating, and a lever plate starts to be inserted into a slit for insertion of lever; and

FIG. 15 is an explanatory plan view showing internal and external connectors of the embodiment that are completely mated with each other.

### DETAILED DESCRIPTION OF THE PREFERRED EMBODIMENTS

There will be detailed below the preferred embodiment of a connector system of the present invention with reference to the accompanying drawings.

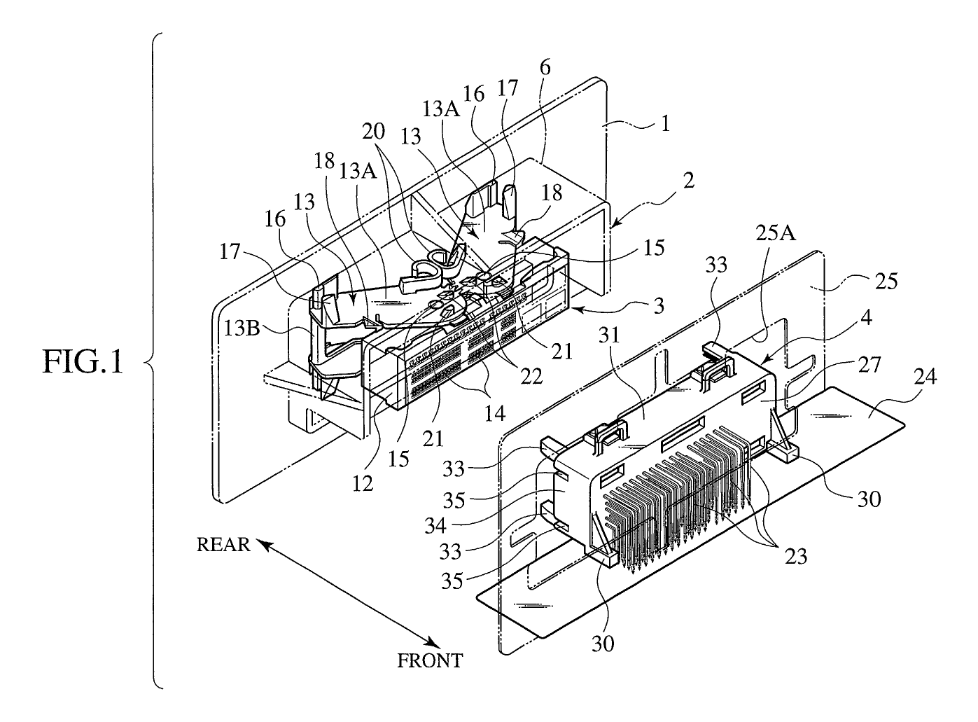

The connector system, as shown in FIG. 1, is constituted generally with mounting component 2 formed to instrument panel 1 such as a stay member of an automobile; external connector 3, as a first connector, mounted to mounting component 2; internal connector 4, as a second connector, mated with the external connector 3 for mounting.

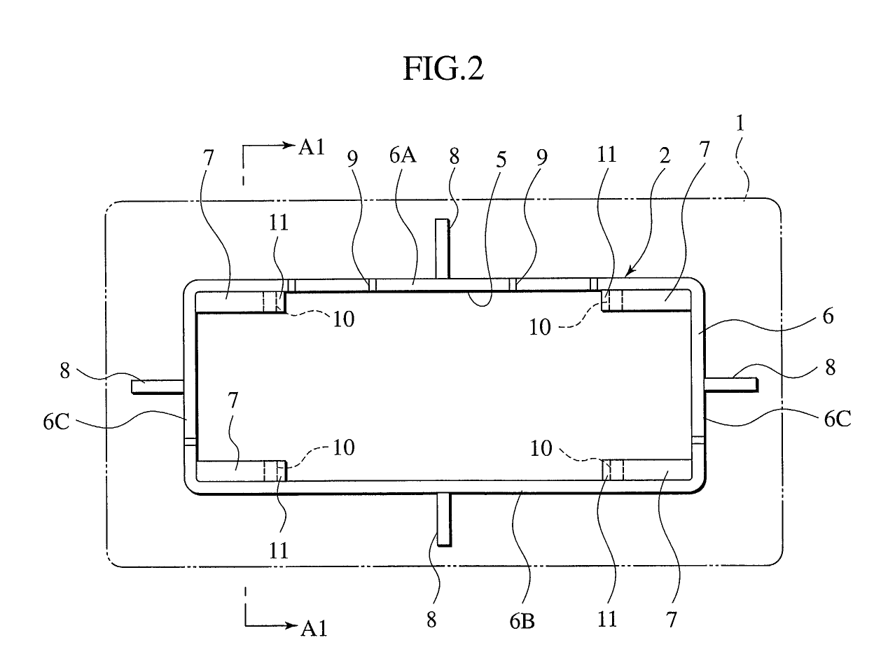

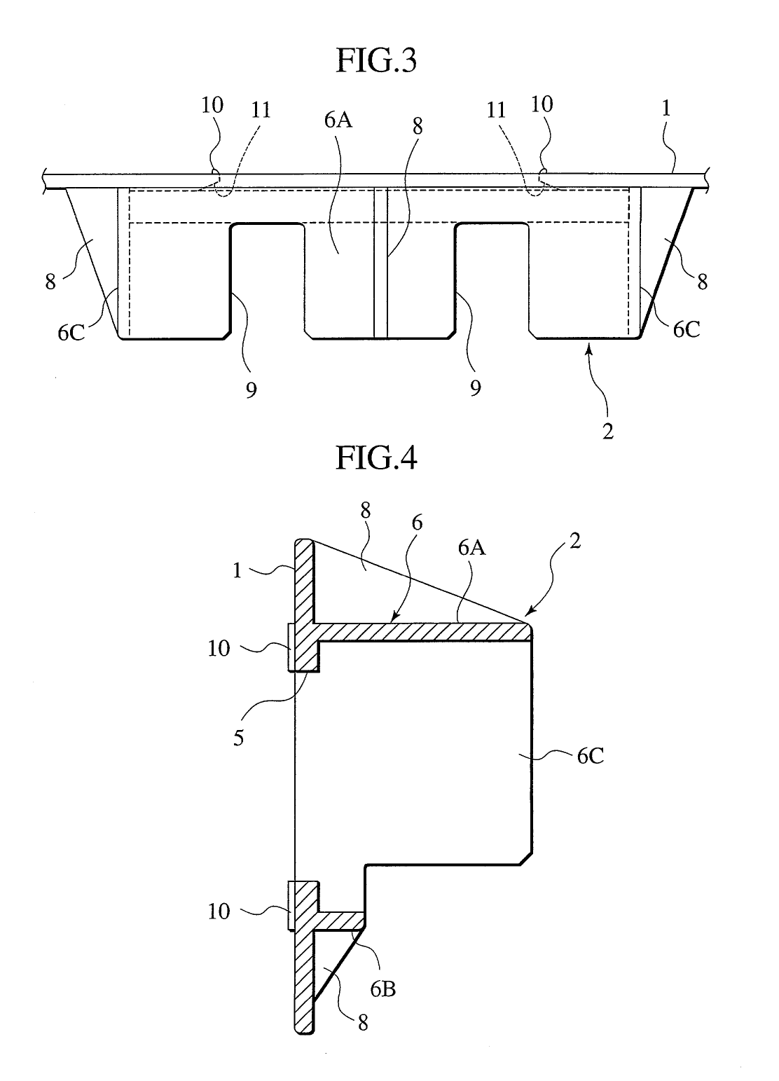

Firstly, the constitution of mounting component 2 is explained by means of FIGS. 2 to 5.

Mounting component 2 includes tubular hood 6 which extends forward from the edge of rectangular opening 5 formed to instrument panel 1.

Close to and projecting from the side edges of either side of the upper and lower edges of opening 5 are engagement plates 7. The plates 7 are each engaged with the free end of engagement lever 13 mounted to external connector 3 as will be described later.

Hood 6 includes upper plate 6A; lower plate 6B; and side plates 6C at both sides. Formed at the center of the outer side of each plate 6A, 6B, 6C, is reinforcement rib 8, integral with panel 1. Upper plate 6A has a longer forward projecting dimension than lower plate 6B. Upper plate 6A is formed with slits 9 at both sides of rib 8.

Each formed on the rear side of the side edge of engagement plate 7 facing in toward the other engagement plate 7, are small locking protruding banks 10 protruding rearward. Each formed on the front side of the side edge are tapered faces 11 for guiding the free end of engagement lever 13 as will be described later.

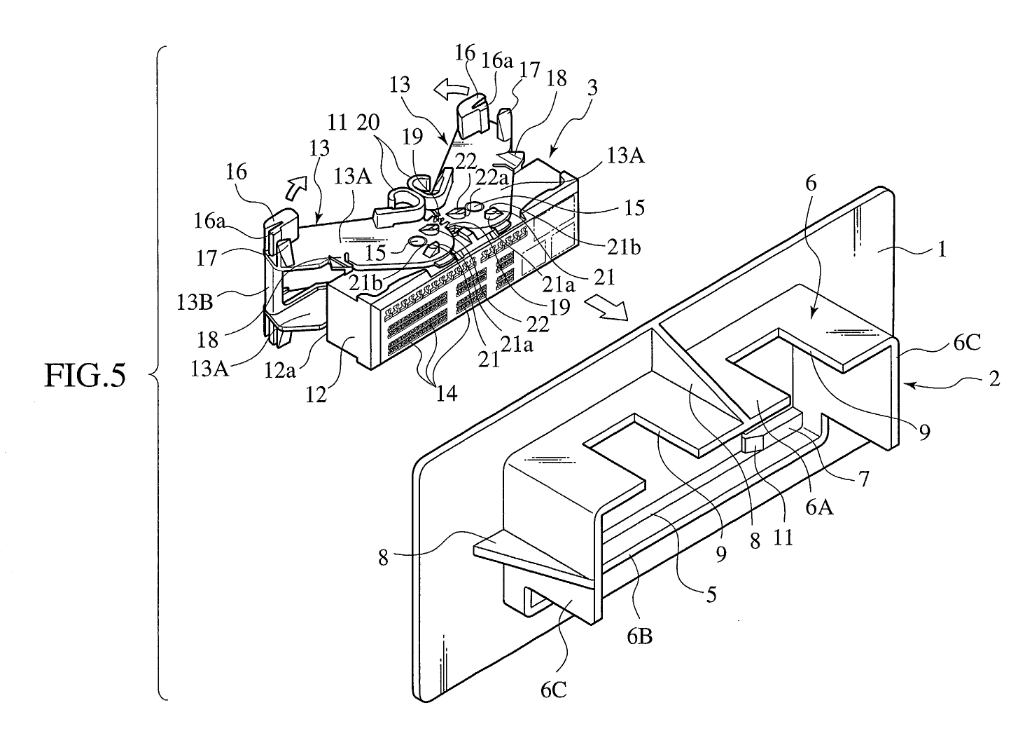

Next, the constitution of external connector 3 is explained. External connector 3 is constituted with external connector housing 12 in substantially rectangular parallepiped shape; and a pair of engagement levers 13 rotatably supported by the connector housing 12. External connector 3 is to be inserted in and engaged with mounting component 2 at the rear side of instrument panel 1, opposite to the front side formed with hood 6, as shown in FIG. 5.

External connector housing 12, as shown in FIGS. 1 and 5, houses external connection terminals 14. Terminals 14 are electrically connected to internal connection terminals 23 of internal connector 4 at the front side of external connector housing 23.

On the top and bottom faces of external connector housing 12, support axes 15, rotatably supporting engagement levers 13A respectively, are located to and protrude from the left and right at a predetermined spacing.

Engagement levers 13, as shown in FIG. 5, include a pair of lever plates 13A of identically shaped; and link parts 13B which are formed integrally to lever plates 13A, to form link between lever plates 13A. Rotatable supporting of lever plates 13A on support axes 15 formed on the top and bottom faces of external connector housing 12, allows respective engagement levers 13 to be rotated. The free end of engagement lever 13 (at link part 13B) projects further rearward from the rear end of external connector housing 12.

On the surface of the free end of lever plate 13A of each engagement lever 13, rear engaging abutment projection 16 projects. Locking part 16a branches and extends from the central portion of projection 16. Rear engaging abutment projection 16 is pressed into contact with the rear side of engagement plate 7 when external connector 3 is mounted to mounting component 2. Locking part 16a is locked with locking bank 10. Forward of rear projection 16 of lever plate 13A of the engagement levers 13 and to one side area relative to the line in connection between rear projection 16 and support axis 15, that is, at a rotation-angularly leading and radially inward position, front engaging abutment projection 17 is provided. Front projection 17 has substantially identical height dimensions relative to rear projection 16. Rear face 17a of front projection 17 is engaged and contacted with the surface of engagement plate 7 when external connector 3 is mounted to mounting component 2. Rear face 17a is curved to allow projection 17 and engagement bank 7 to be relatively rotated.

Formed to lever plate 13A at the edge of another side relative to the line of connection between rear engagement projection 16 and support axis 15, is provisional locking piece 18 for provisional locking with the rear edge of external connector housing 12. Stopper 18a protrudes from one side of provisional locking piece 18, contacting rear end 12a of external housing 12. Formed to the opposed edges of lever plates 13A, gears 19 are meshed with each other. By forming the meshed gears 19 to adjacent lever plates 13A, lever plates 13A rotate in synchrony, in opposite directions to each other.

Lever plates 13A are each provided with resilient spring piece 20 as a resilient member at the back of gear 19, leading from gear 19 at a rotational angle. Spring pieces 20 are provided to both engagement levers 13A respectively. Spring pieces 20 are configured in a curved shape to enlarge in width toward the other spring piece 20 each other. Spring pieces 20 contact together in an initial state where provisional locking pieces 18 are locked with the rear end of external connector housing 12. This causes spring pieces 20 to be biased for repulsion when engagement levers 13 respectively rotate the free ends thereof to come close to each other.

Lever plates 13A each have engagement protrusions 21 protruding upwardly or downwardly at the end therefrom, in front of support axis 15. Engagement protrusions 21 each include a curved side face 21a directed radially outward; and a flat side face 21b directed radially inward. Engagement protrusion 21 is guided in internal connector 4 and has a function as the slipping-out stopper of internal connector 4. Provided between support axis 15 and gear 19 of lever plate 13A is protrusion 22 as the engaging abutment on engagement receiver 36. Protrusion 22 has a curved end 22a in a counterclockwise direction. Protrusion 22 has the function of being brought into contact with the front end of internal connector 4, rotating lever 13 due to the pressing force received from internal connector 4, and moving internal connector 3 rearwardly.

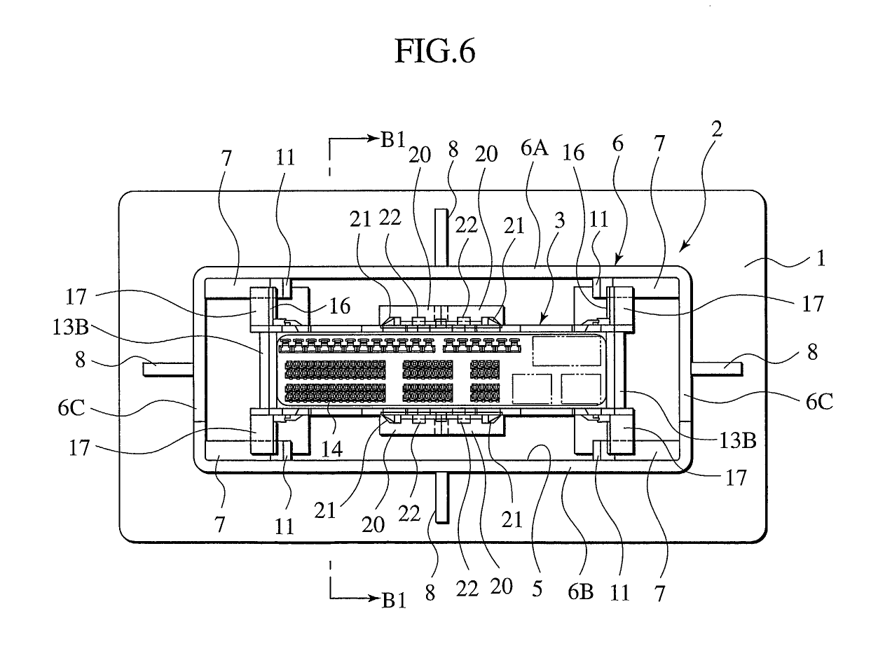

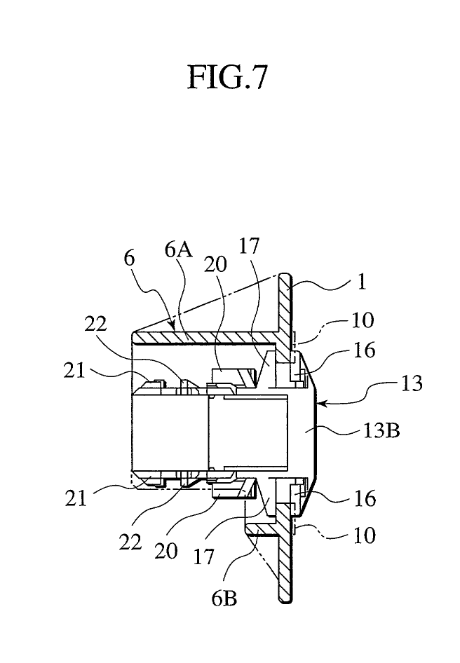

The method for assembling external connector 3 to mounting component 2 is explained by the use of FIGS. 5 to 7. Firstly, external connector 3, as shown in FIG. 5, is inserted at the rear side of instrument panel 1 in the direction shown by the arrow. With engagement plate 7 formed to mounting component 2, the edges 13C of engagement lever 13 come in contact, which exerts moment on engagement levers 13. The moment starts respective engagement levers 13 to be rotated about respective support axes 15 for coming close to each other (the direction shown by the arrow in FIG. 5). Simultaneously, spring pieces 20 formed to engagement levers 13 contact each other to store repulsion for the detachment of the free ends of levers 13 from each other. When, due to the force overcoming the repulsion, external connector 3 is pushed into mounting component 2, rear projections 16 each come in contact with the rear side of mounting plate 7, and front projections 17 each come in contact with the front side of mounting plate 7. This causes mounting plate 7 to be gripped between the front and rear projections 16 and 17, thus mounting external connector 3 to mounting component 2, as shown in FIGS. 6 and 7.

The embodiment employs spring piece 20 as a resilient member. On the other hand, for example, coil springs arranged to repulse each other, or a member with a elasticity, such as a rubber is also preferably adopted. The embodiment has the resilient member provided to engagement levers 13. On the other hand, it is also the preferable constitution that the resilient member is fixed at an intermediate position between both levers 13 in external housing 12.

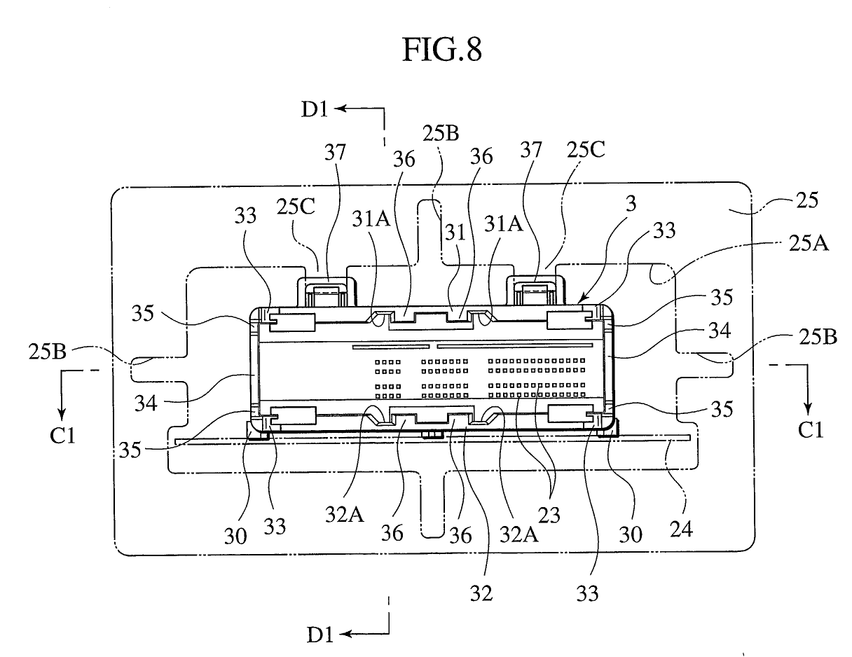

Next, the constitution of internal connector 4 is explained. Internal connector 4, as shown in FIGS. 1 and 8, is fixed to base plate 24 of an equipment, and is exposed from the opening 25A of escutcheon 25 rising at the rear of the equipment. Opening 25A of escutcheon 25 is formed with slits 25B for ribs corresponding to reinforcement ribs 8; and supporting projection 25C for supporting internal connector 4.

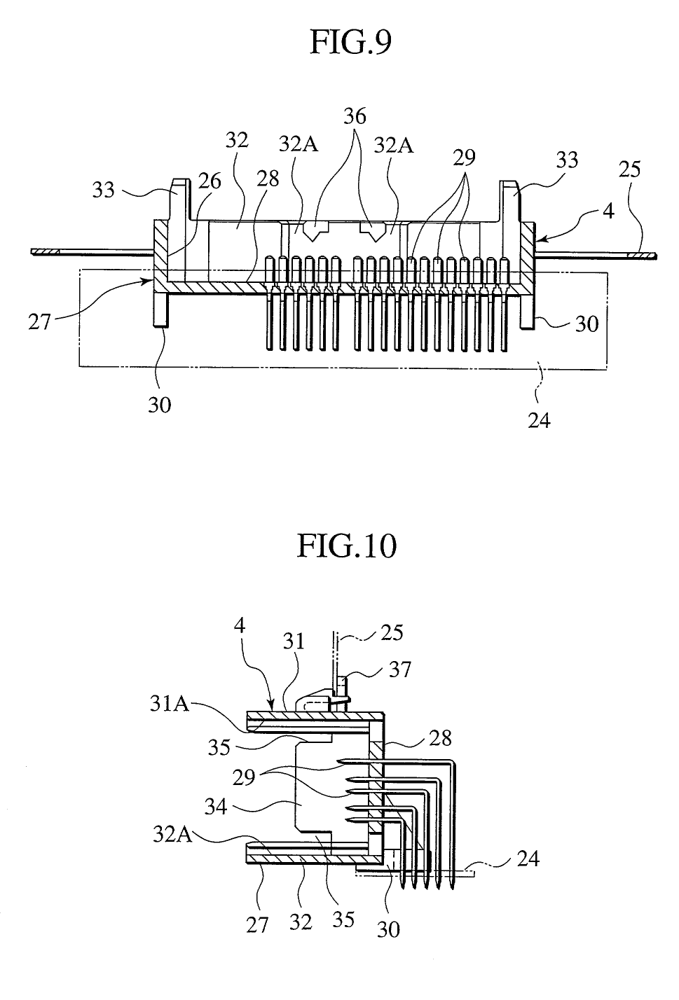

Internal connector 4, as shown in FIG. 9, includes: internal housing 27 which is formed on the front face with mating recess 26 to be mated with external connector 3; and internal connection terminals 29 which pass through the bottom plate 28 forming the bottom of recess 26 and project into recess 26.

Both sides of the lower portion of the rear end of internal housing 27 are formed with base-plate fixing parts 30 which extend rearwardly. Projecting from either side of top and bottom plates 31, 32 are arms 33 for the disengagement of provisional locking, which extend forwardly. Disengagement arms 33 each have the function of flexing provisional locking piece 18 for disengagement from the rear end 12a of external housing 12 in the provisional locking state during the mating of external and internal connectors 3, 4.

Internal housing 27 has slits 35 as cuts for insertion of lever which are each cut deeply rearward at a predetermined dimension, formed at the lower and upper positions on the front end face of both side plates 34.

The insertion of engagement levers 13 supported by external connector 3 into slits 35 each formed to side plate 34 of internal housing 34 allows an increase in the amount of rotational motion of lever 13. This results in enlargement in the amount of the mating movement (extra portion for mating) of external and internal connectors 3, 4. Thus, the amount of the rotational motion of each engagement levers 13 is ensured, and longitudinal lengthening of engagement lever 13 for increasing the amount of the mating movement is rendered unnecessary, thus achieving the compactization of engagement lever 13.

The respective internal wall faces of top and bottom plates 31, 32 have respective pair of guide channels 31A, 32A corresponding to front protrusions 21 formed to external housing 12, formed thereon. On the respective insides of channels 31A, 32A, pairs of engagement receivers 36 to be engaged with front protrusions 21 are formed. Receivers 36 each have a flat side face 36a to be abutted on the end face 22a of rear protrusion 22. Receivers 36 each have another side face 36b oblique to and opposed to side face 36a. This side face 36b is to be abutted on the side face 21a of front protrusion 21. Receivers 36 further have another side face 36c which extends from side face 36b, obliquely to side face 36a. This side face 36c is to be slid against side face 21b. The side faces 36b, 36c constitute at an acute angle.

Front protrusions 21 introduced from channels 31A, 32A each move around the circumferential form with side faces 36a, 36b, 36c, to be engagingly abutted on engagement receiver 36.

The top face of top plate 31 of internal connector housing 27 has support protrusion 37 to be fixed to support projecting piece 25C of escutcheon 25.

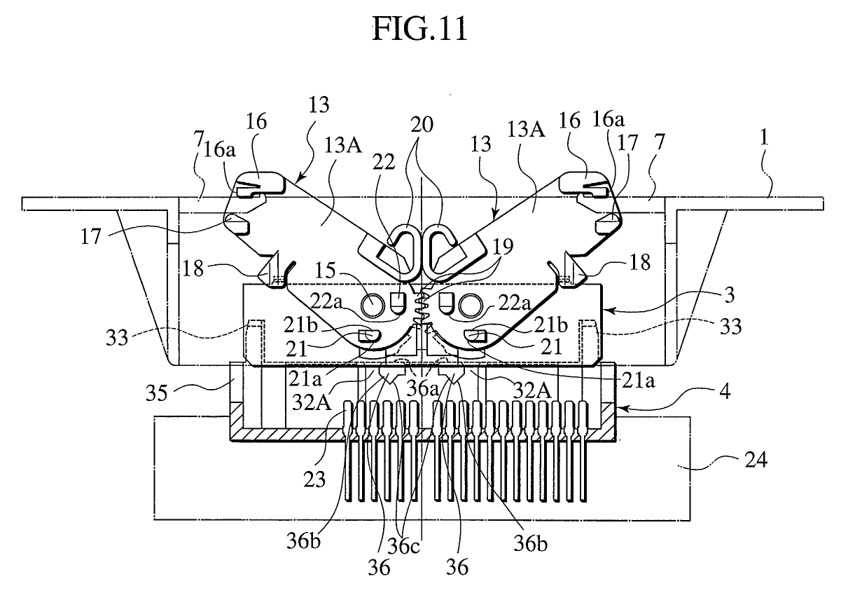

The aforementioned has explained the connector system of the embodiment. Next, the operation method for the assembly of internal connector 4 to external connector 3 mounted to mounting component 2, the function, and the working are explained, using FIGS. 11 to 15. Escutcheon 25 is omitted in FIGS. 11 to 15.

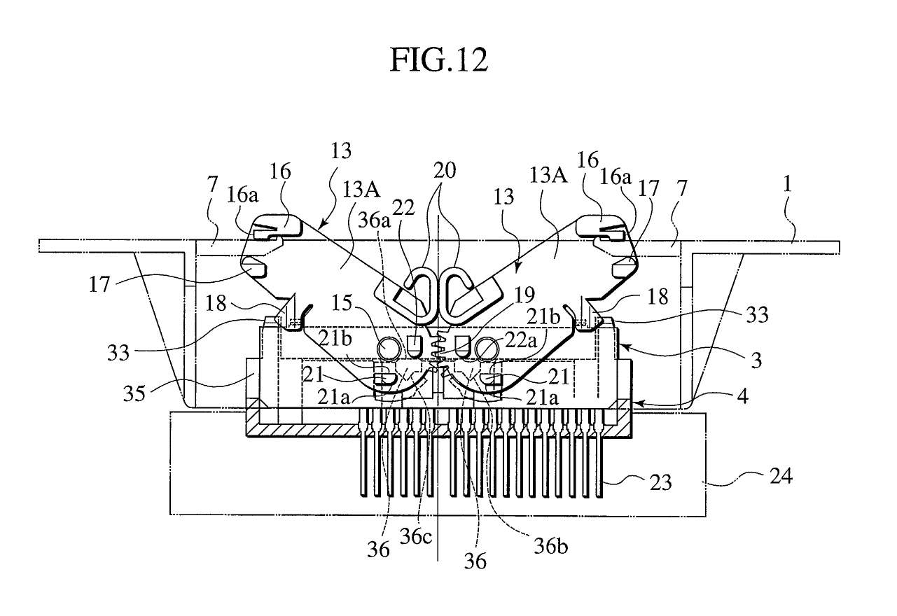

Firstly, with external connector 3 mounted to mounting component 2, as shown in FIG. 11, internal connector 4 starts to be mated. Internal connector 4 comes close to external connector 3. When the mating starts, as shown in FIG. 12, front protrusions 21 at the front ends of levers 13 of external connector housing 12 are housed in guide channels 31A, 32A on the top and bottom internal wall faces of internal connector 4. The end of each disengagement arm 33 reaches provisional locking piece 18.

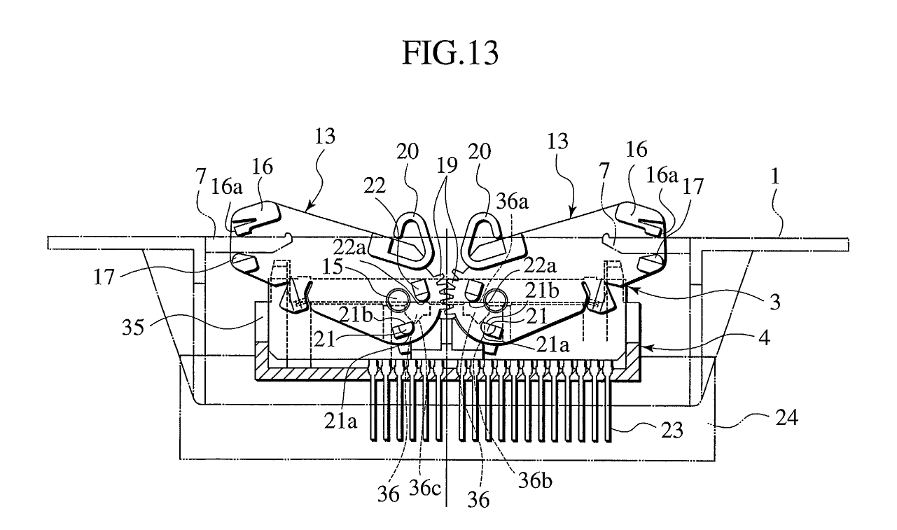

Hereinafter, when internal connector 4 is further pushed into external connector 3, as shown in FIG. 13, the end face 36a of receiver 36 is engagingly abutted on rear protrusion 22 to be pushed rearwardly. Disengagement arms 33 each flex provisional locking piece 18 to be disengaged from the rear end 12a of external connector housing 12 in a locking state. At this time, front protrusions 17, formed on the pair of engagement levers 13, are subjected to repulsion on the front face of engagement plate 7. This causes engagement levers 13 to be rotated to expand and open each other. Engagement levers 13 are meshed together by gears 19 to rotate in synchronously. This causes front protrusions 21 at the front ends of levers 13 to each be rotated and to be moved around to the rear of engagement receiver 36. In other words, front protrusion 21 rotates on its curved face 21, sliding against the oblique face 36b. In accordance with this operation, front and rear protrusions 16, 17 are slid transversely and outwardly from engagement plate 7 respectively.

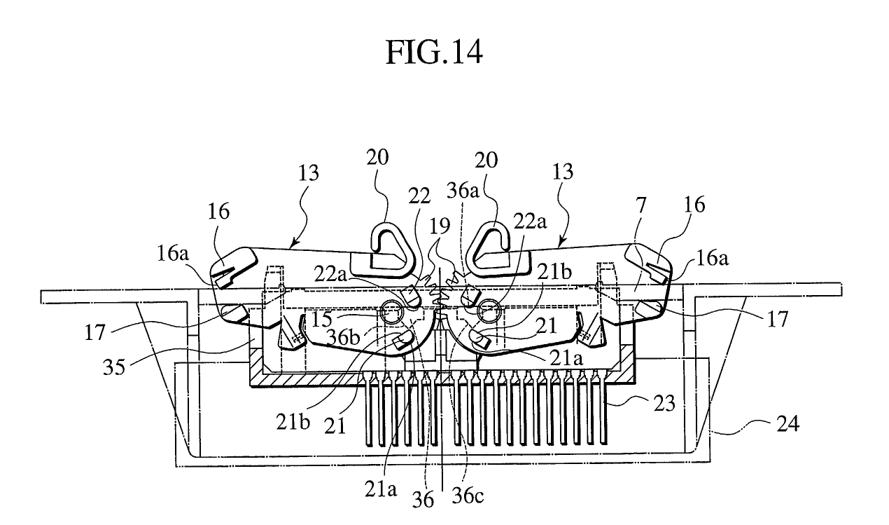

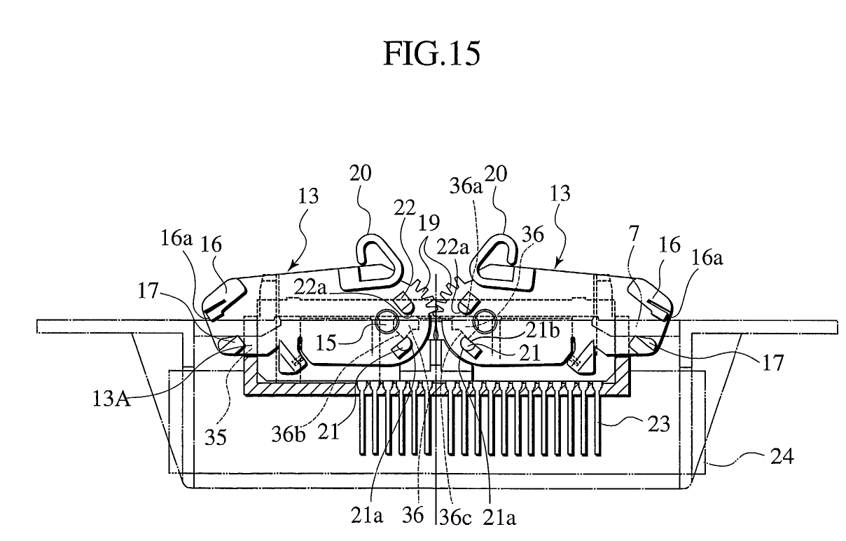

When internal connector 4 is further pushed as shown in FIG. 13, spring pieces 20 are detached from each other. Front protrusions 21 at the frond ends of levers 13, as shown in FIG. 14, each rotate to move around toward the rear of engagement receiver 36. In other words, when the connection point between side faces 21a, 21b corresponds with the connection point of inclined face 36b, 36c, oblique face 36c and side face 21b start to contact and slide against each other. Further more, with pushing of internal connector 4, as shown in FIG. 15, front protrusion 21 completely moves around in the rear of receiver 36 for engagement, thus functioning as a slipping-out stopper of internal connector 4. At this time, lever plates 13A are each inserted into the slit 35, preventing further mating.

By the aforementioned operation, the working of the connecting and mating of internal connector 4 to external connector mounted to mounting component 2 has finished.

In the embodiment with the constitution, the engaging abutment of provisional locking piece 18 of lever 13 on the rear end of external connector housing 12 prevents lever 13 from rotation. Strengthening of the holding force of lever 13 in an initial state allows the secure provisional locking to be performed.

In the embodiment, the pushing of internal connector 3 to mounting component 2 against a repulsion of spring piece 20 allows the automatic mounting of external connector 3 to mounting component 2, thus allowing the simple performance of the mounting operation of the connector.

The embodiment has gears 19 for meshing together with engagement levers 13. When external connector 3 is subjected to an external force, left and right engagement levers 13 distribute the force to be applied equally to mounting component 2, thus resulting in the advantage of the tendency to the difficult slipping-out of mounting component 2.

In the embodiment, formed to side plate 34 of internal connector housing 27, slit 35 for insertion of lever is for the insertion of lever plate 13A of engagement lever 13 rotatably supported on external connector 3. This allows increase in the amount of the rotational motion of engagement lever 13. Unless this slit 35 is formed, in order to ensure the identical rotational amount, the enlargement of engagement lever 13 is necessary, thus rendering the connector system large-sized. In the embodiment, the forming of slit 35 allows engagement lever 13 to be small-sized, thus achieving the compact connector system.

In addition, in the embodiment, in dependence on the rotation of engagement lever 13, rear and front protrusions 16, 17 securely hold engagement plate 7 therebetween. This allows the prevention of external connector 3 from the generation of looseness.

The aforementioned has explained the embodiment. The invention is not limited to them, being possible for every kind of design change accompanied by essential points. For example, the above-mentioned embodiment employs engagement lever 13 of the configuration for moving around on the top and bottom faces of external housing 12. On the other hand, it is preferably constituted with one of the top and bottom faces that is provided with a pair of engagement levers in a plate shape.

In the aforementioned embodiment, external connector 3 is adapted as a first connector, and internal connector 4 is adapted as a second connector. On the other hand, it is preferable that employed as a first connector mounted to mounting component 2 is an internal connector, and employed as a second connector is an external connector.

In addition, the aforementioned embodiment is constituted that mounting component 2 is provided to instrument panel 1. On the other hand, the embodiment is not limited to this.

The content of Japanese Patent Application No. 2000-262868 is incorporated herein by reference.

What is claimed is:

1. A connector system comprising:
a first connector comprising:
a first housing; and
a pair of rotary members supported on the first housing for rotating in opposite directions to each other, rotary members each comprising a first engagement member; and
a second connector configured to be mated with the first connector, the second connector comprising a second housing configured to be mated with the first housing,
the second housing comprising:
a pair of first mating engagement members, first mating engagement members each configured to be abutted on the first engagement member for rotating a rotary member, and to be locked with the first engagement member; and
a pair of cuts, cuts each being for inserting the rotary member thereinto when the rotary member rotates.

2. A connector system device according to claim 1,
wherein the first engagement members each comprising:
a first protrusion configured to be abutted on a first mating engagement member, the first protrusion to be rotated on the first mating engagement member when the rotary member rotates; and
a second protrusion depart from the first protrusion at a rotational angle, the second protrusion being configured to be moved around the rotary member and to be opposed to the first protrusion relative to the first mating engagement member when the rotary member rotates.

3. A connector system according to claim 1,
wherein the pair of rotary members each comprise:
a second engagement member configured to be locked with a mounting object, the second engagement member to be slid against the mounting object when the rotary member rotates.

4. A connector system according to claim 3,
wherein the second engagement member is opposed to a first engagement member relative to a rotational axis of the rotary member.

5. A connector system according to claim 1,
wherein the rotary members each comprise:
a locking member locked with the first housing, the locking member to be disengaged when the first housing is mated with the second housing.

6. A connector system according to claim 1,
wherein respective rotary members comprise:
respective gears meshed with each other.

7. A connector system according to claim 7,
wherein respective rotary members comprise:
respective biasing members biased against each other.

8. A connector system comprising:
a first connector having an engagement lever rotatably supported thereon; and
a second connector configured to be mated with the first connector, the second connector having a housing formed with a slit, the second connector configured to rotate the engagement lever for inserting a side portion of a free end of the engagement lever into the slit.

9. A connector system according to claim 8,
wherein with the free end being locked with a mounting component, pressing of the second connector to the first connector causes the first connector to be inserted into the housing, and a rotation of the engagement lever causes first and second connectors to be mated with each other.
